(19) United States
(12) Patent Application Publication
(10) Pub. No.: US 2014/0062254 A1
(43) Pub. Date: Mar. 6, 2014

(54) Permanent Magnet Rotating Electrical Machine

(71) Applicant: Hitachi Automotive Systems, Ltd., Hitachinaka-shi (JP)

(72) Inventors: Junnosuke NAKATSUGAWA, Hitachi (JP); Hiroshi KANAZAWA, Hitachiota (JP); Hidefumi IWAKI, Hitachinaka (JP)

(21) Appl. No.: 13/940,332

(22) Filed: Jul. 12, 2013

(30) Foreign Application Priority Data
Aug. 31, 2012 (JP) 2012-190825

(51) Int. Cl. H02K 1/27

(52) U.S. Cl. CPC H02K 1/2773
USPC 310/216.094

(57) ABSTRACT

A permanent magnet rotating electrical machine is configured to include a stator that includes a stator core and a winding wound around a teeth portion of the stator core, a rotor rotatably arranged with respect to the stator with a gap, and in which a rotor core and a plurality of permanent magnets having different poles are alternately arranged in a circumferential direction, and a groove provided in a surface of the rotor core, the surface facing the stator, in a manner symmetric about a center line of the permanent magnet in the circumferential direction.

### BACKGROUND OF THE INVENTION

1. Field of the Invention

The present invention relates to a permanent magnet rotating electrical machine.

2. Description of the Related Art

Among permanent magnet rotating electrical machines, a permanent magnet rotating electrical machine has been known in which a permanent magnet has a cross section longer in a radial direction than in a circumferential direction and is magnetized in the circumferential direction, and the permanent magnets are alternately arranged such that magnetization directions of adjacent magnets face each other. While such type of a motor can make output torque larger, there is a problem in that cogging torque also becomes larger.

Therefore, for example, JP 2004-254496 A discloses that a groove for controlling distribution of a magnetic flux generated in a permanent magnet is formed in a facing surface of a stator or of a rotor in a gap between the stator and the rotor.

### SUMMARY OF THE INVENTION

To reduce cogging torque in JP 2004-254496 A, it is important how to arrange the groove in a core in order to control the distribution of a magnetic flux. JP 2004-254496 A discloses that an oblique groove is formed, which obliquely passes with a predetermined angle with respect to an axial line in an axial direction.

However, to form the oblique groove, it is necessary to differentiate the position of the groove for each thin plate that configures a layered core. For example, when the layered core is manufactured with metal mold punching, a metal mold is required for each thin plate, so that a manufacturing cost is increased.

Therefore, an object of the present invention is to provide a permanent magnet rotating electrical machine that suppresses a decline in torque and reduces cogging torque without increasing in manufacturing cost.

To solve the above described problem, a configuration described in the claims is employed, for example. The present application includes a plurality of means that solves the above-described problem. Taking an example, a permanent magnet rotating electrical machine includes: a stator including a stator core and a winding wound around a teeth portion of the stator core; a rotor rotatably arranged with respect to the stator with a gap, and in which a rotor core and a plurality of permanent magnets having different poles are alternately arranged in a circumferential direction; and a groove provided in a surface of the rotor core, the surface facing the stator, in a manner approximately symmetric about a center line of the permanent magnet in the circumferential direction.

According to the present invention, a permanent magnet rotating electrical machine that suppresses a decline in torque and reduces cogging torque without increasing in manufacturing cost of the permanent magnet rotating electrical machine. Problems, configurations, and effects other than the above description will be shown in the description of embodiments below.

### BRIEF DESCRIPTION OF THE DRAWINGS

FIG. 1 is an ¼ cross sectional view of a permanent magnet rotating electrical machine of a first embodiment of the present invention;

FIG. 2 is an ¼ cross sectional view of the permanent magnet rotating electrical machine provided with no groove;

FIG. 3 is an example of a cogging torque wave of the first embodiment of the present invention;

FIG. 4 is magnetic flux distribution in the vicinity of an air gap of the first embodiment of the present invention;

FIG. 5 is magnetic flux distribution in the vicinity of an air gap in a case where a groove is not provided (1);

FIG. 6 is an ¼ cross sectional view of a permanent magnet rotating electrical machine of a second embodiment of the present invention;

FIG. 7 is an example of a cogging torque wave of the second embodiment of the present invention;

FIG. 8 is magnetic flux distribution in the vicinity of an air gap of the second embodiment of the present invention;

FIG. 9 is magnetic flux distribution in the vicinity of an air gap in a case where a groove is not provided (2);

FIG. 10 is an ¼ cross sectional view of a permanent magnet rotating electrical machine of a third embodiment of the present invention;

FIG. 11 is an example of a cogging torque wave of the third embodiment of the present invention;

FIG. 12 is an ¼ cross sectional view of a permanent magnet rotating electrical machine of a fourth embodiment of the present invention;

FIG. 13 is an example of a cogging torque wave of the fourth embodiment of the present invention;

FIG. 14 is an ¼ cross sectional view of a permanent magnet rotating electrical machine of a fifth embodiment of the present invention;

FIG. 15 is an example of a cogging torque wave of the fifth embodiment of the present invention;

FIG. 16 is an ½ cross sectional view of a permanent magnet rotating electrical machine of a sixth embodiment of the present invention;

FIG. 17 is an ½ cross sectional view of a permanent magnet rotating electrical machine provided with no groove;

FIG. 18 is an example of a cogging torque wave of the sixth embodiment of the present invention;

FIG. 19 is magnetic flux distribution in the vicinity of an air gap of the sixth embodiment of the present invention;

FIG. 20 is an ½ cross sectional view of a permanent magnet rotating electrical machine of a seventh embodiment of the present invention;

FIG. 21 is an example of a cogging torque wave of the seventh embodiment of the present invention;

FIG. 22 is magnetic flux distribution in the vicinity of an air gap of the seventh embodiment of the present invention; and

FIG. 23 is a cross sectional view of a permanent magnet rotating electrical machine.

### DESCRIPTION OF THE PREFERRED EMBODIMENTS

Hereinafter, embodiments will be described with reference to the drawings.

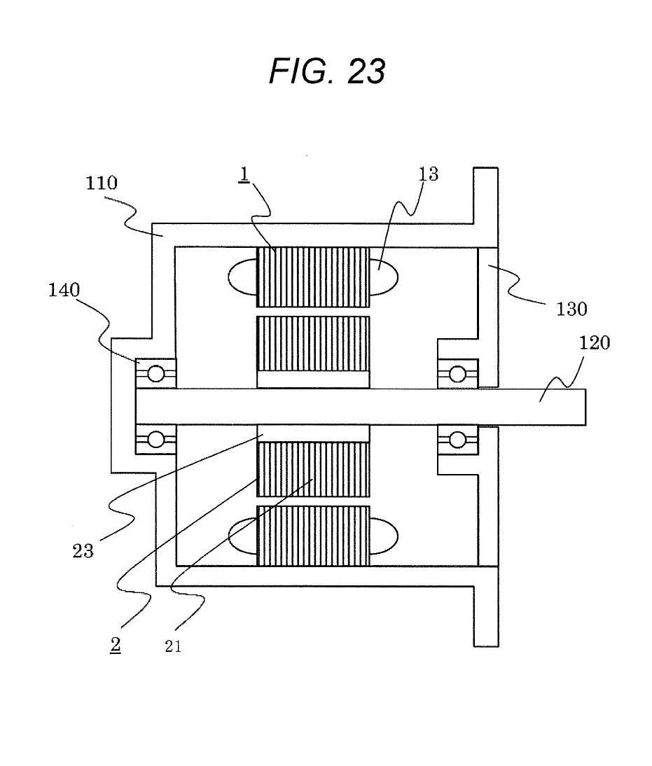

First, a configuration of a rotating electrical machine common to embodiments of the present invention will be described. FIG. 23 illustrates a cross sectional view along an axial direction of a permanent magnet rotating electrical machine (direction parallel to a rotation axis of a rotor). The permanent magnet rotating electrical machine includes a stator 1 and a rotor 2 facing at an inside in a radial direction of the stator 1, and an air gap exists between the stator 1 and the rotor 2. The stator 1 is fixed to a housing 110, and is provided with a concentrated winding stator winding 13. The rotor 2 includes a rotor core 21 in which a plurality of magnetic steel plates is layered, a nonmagnetic material 23 is arranged at an inside in a radial direction of the rotor core 21, and a shaft 120 is arranged at a further inside in the radial direction of the rotor core 21. The shaft 120 is rotatably supported by a bearing 140 fixed to the housing 110 or a flange 130.

### First Embodiment

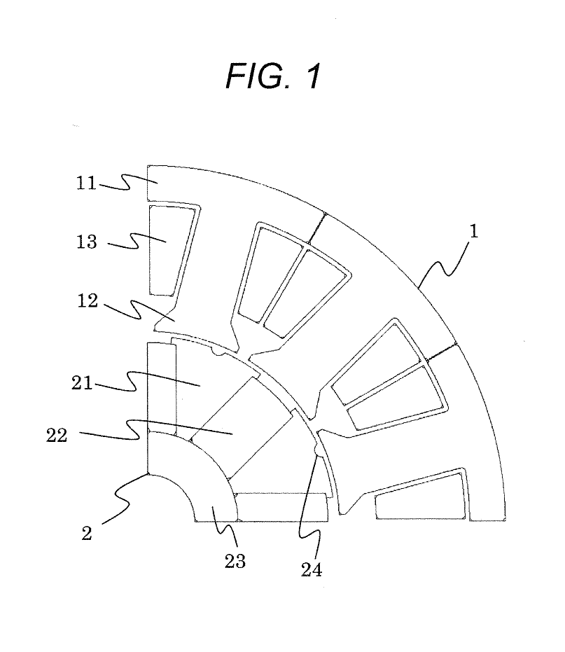

Hereinafter, a first embodiment of the present invention will be described with reference to FIGS. 1 to 5. In the embodiment, as an example of a combination of two poles of a rotor magnetic pole with respect to three stator teeth, a case of twelve stator teeth and eight poles of the rotor magnetic pole will be described.

FIG. 1 illustrates an ¼ cross sectional view along a surface perpendicular to an axial direction of a permanent magnet rotating electrical machine according to the embodiment. The permanent magnet rotating electrical machine includes a stator 1 and a rotor 2 facing at an inside in a radial direction of the stator 1, and an air gap exists between the stator 1 and the rotor 2. The stator 1 includes a stator core 11 in which a plurality of magnetic steel plates is layered, and the stator core 11 includes a plurality of stator teeth 12, and a stator winding 13 is wound around each tooth in a concentrated winding manner. The rotor 2 has a rotor core 21 in which a plurality of magnetic steel plates is layered and a permanent magnet 22 having a cross section longer in a radial direction than in a circumferential direction alternately arranged in the circumferential direction. The permanent magnet 22 is magnetized in the circumferential direction, and adjacent magnets are alternately magnetized such that magnetization directions of the adjacent magnets face each other. A member in contact with the rotor core 21 and the permanent magnet 22 at an inside in a radial direction thereof is configured of a nonmagnetic material 23, and a shaft (not illustrated) is arranged in a further inside in the radial direction.

A groove 24 symmetric about a center line of the permanent magnet 22 in the circumferential direction and on a center line of the rotor core 21 in the circumferential direction is formed in a surface of the rotor core 21, the surface facing the stator 1.

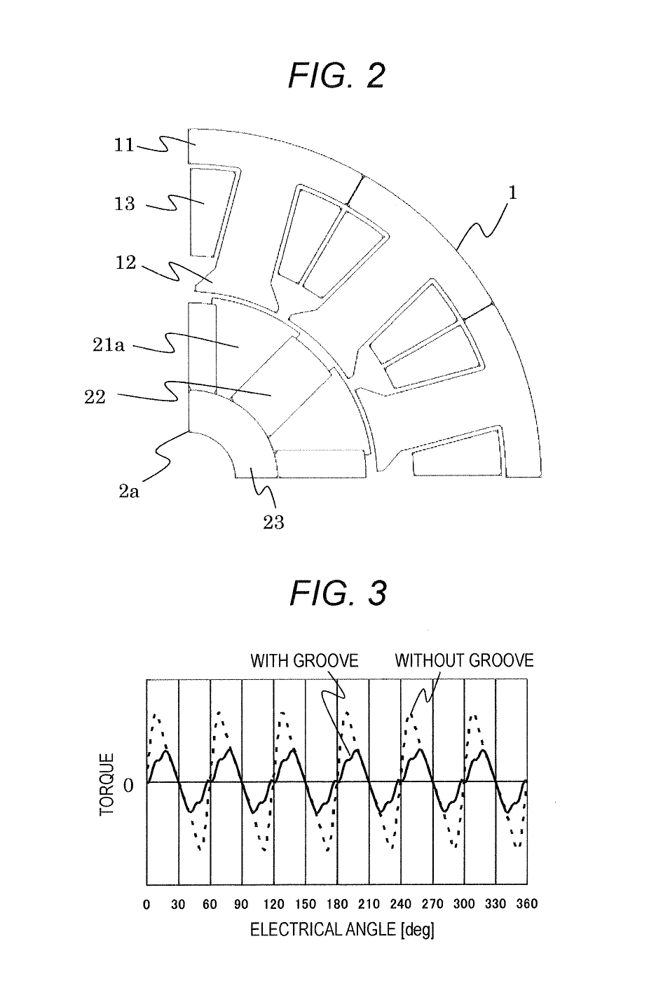

FIG. 2 is an ¼ cross sectional view of a permanent magnet rotating electrical machine provided with no groove in a surface of a rotor core. Differences from FIG. 1 are that the rotor core 21 is changed into a rotor core 21a, and a groove is not provided in a surface of the rotor core 21a. Accordingly, the rotor 2 is changed into a rotor 2a. Things other than the above are similar to FIG. 1.

FIG. 3 illustrates waves of cogging torque in a case where the groove 24 is provided in the surface of the rotor core and in a case where the groove 24 is not provided. Here, the case where the groove 24 is not provided refers to the shape illustrated in FIG. 2. The positions of the rotors in FIGS. 1 and 2 correspond to the position of an electrical angle of 30 degrees in FIG. 3. In FIG. 3, negative torque acts when the electrical angle proceeds in a forward direction from 30 degrees, and positive torque acts when the electrical angle proceeds in a backward direction. Therefore, even the electrical angle proceeds in either direction, the torque acts in a direction of an original position to which the rotor is returned. That is, the position of the electrical angle of 30 degrees is a stability point. Due to symmetry of the shapes of the stator and the rotor, the stability points appear by every electrical angle of 60 degrees such as the electrical angles of 90 degrees and 150 degrees. Meanwhile, the electrical angles of 0 degree, 60 degrees, and the like are instability points, which appear by every electrical angle of 60 degrees.

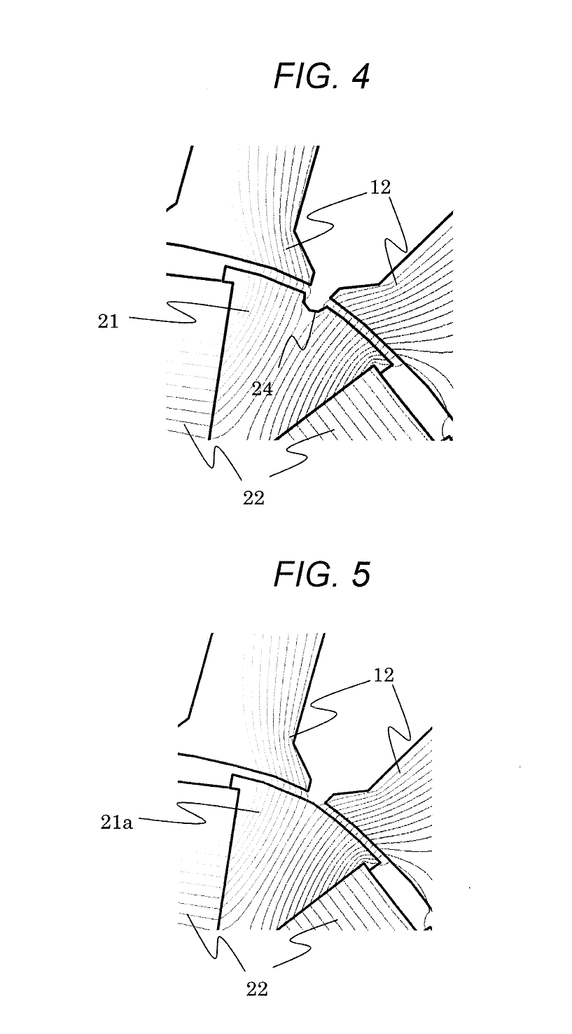

In a case where the groove 24 is provided in FIG. 3, the cogging torque in the vicinity of the electrical angle of 0 degree is considerably reduced. A factor of this effect will be described with reference to FIGS. 4 and 5.

FIG. 4 illustrates magnetic flux distribution in the vicinity of an air gap at a position of the rotor of the electrical angle of 0 degree in the case where the groove 24 is provided, and FIG. 5 illustrates magnetic flux distribution in the case where the groove is not provided. In FIG. 5, a magnetic flux having passed through the permanent magnet 22 passes through a route of the rotor core 21a→the air gap→the stator teeth 12. If the rotor slightly moves in the forward direction or in the backward direction, the air gap between the rotor and the stator is constant, and a facing area of the rotor and the stator teeth does not change. Therefore, force to keep the rotor in this position is weak, and this is a factor of the instability point.

Meanwhile, in FIG. 4, the groove 24 is provided in the surface on the center line of the rotor core in the circumferential direction. Therefore, if the rotor moves in the forward direction or in the backward direction, the air gap between the rotor and the stator is enlarged, and the facing area of the rotor and the stator teeth becomes smaller. Therefore, torque returning to the position of FIG. 4 acts, and the instability point in FIG. 3 is eased.

As described above, the groove 24 is provided in the surface of the rotor core in a manner symmetric about the center line of the permanent magnet in the circumferential direction and on the center line of the rotor core in the circumferential direction, whereby the cogging torque has an decrease in amplitude, and an effect of reduction of vibration/noise can be obtained.

### Second Embodiment

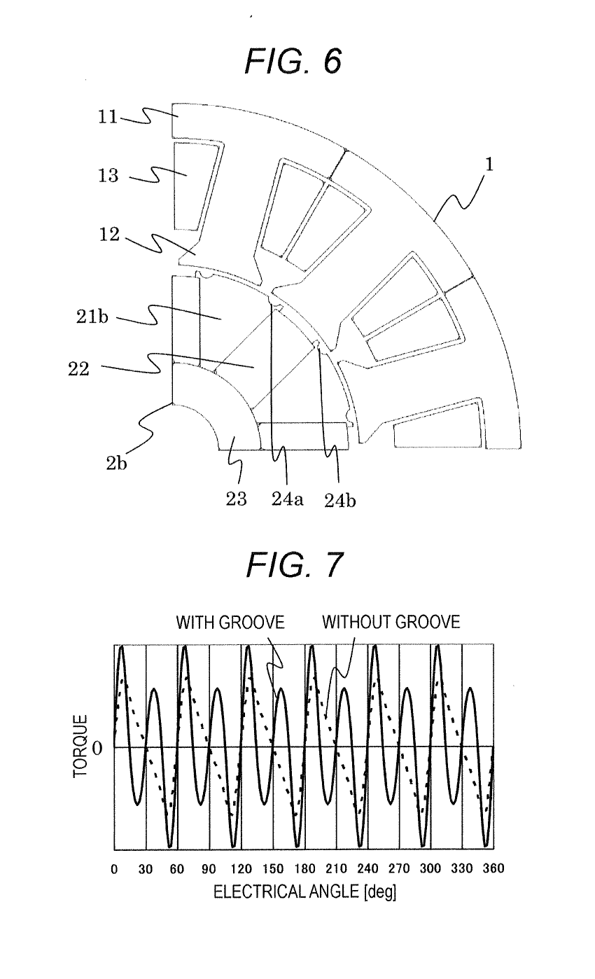

Hereinafter, a second embodiment of the present invention will be described with reference to FIGS. 6 to 9. In the embodiment, as an example of a combination of two poles of a rotor magnetic pole with respect to three stator teeth, a case of twelve stator teeth and eight poles of the rotor magnetic pole will be described.

FIG. 6 illustrates an ¼ cross sectional view of a permanent magnet rotating electrical machine of the second embodiment of the present invention. Differences from FIG. 1 are that the rotor core 21 is changed into a rotor core 21b, and grooves 24a and 24b are formed in surfaces of the rotor cores 21b, the surfaces facing a stator 1, in a manner symmetric about a center line of a permanent magnet 22 in a circumferential direction and in vicinities of the permanent magnet 22. Accordingly, the rotor 2 is changed into a rotor 2b. Note that a pitch between two grooves lining across the permanent magnet 22 in the circumferential direction approximately accords with the width of a surface of a stator tooth 12 in the circumferential direction, the surface facing the rotor 2b. Things other than the above are similar to FIG. 1.

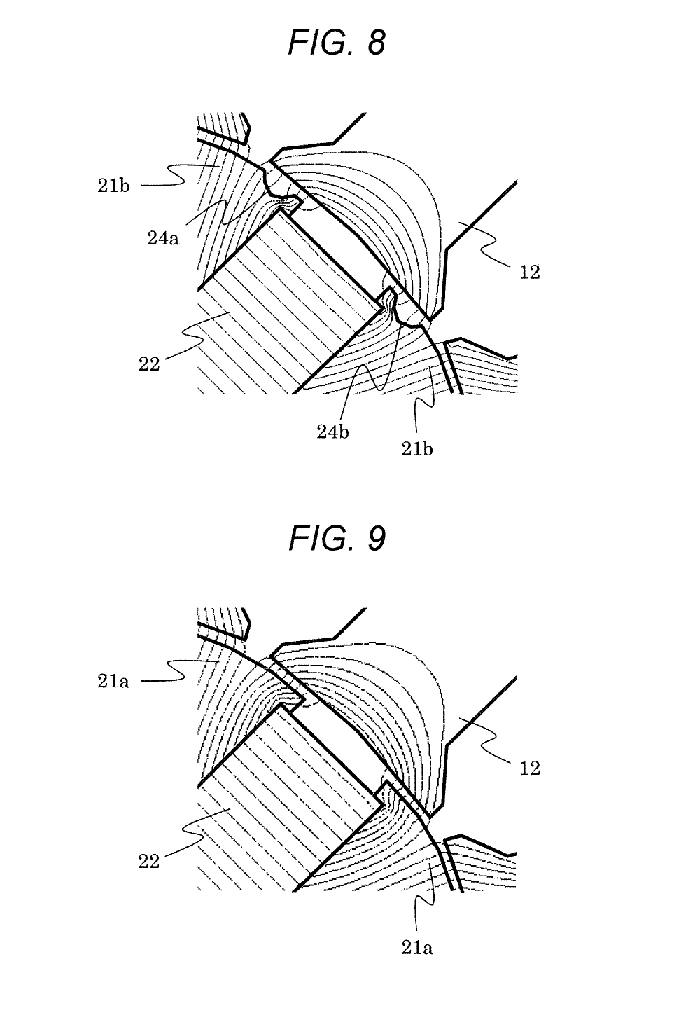

FIG. 7 illustrates waves of cogging torque in a case where the grooves 24a and 24b are provided in the surface of the rotor core and in a case where the grooves are not provided. Here, the case where the grooves 24a and 24b are not provided refers to the shape illustrated in FIG. 2. The position of the rotor in FIG. 6 corresponds to the position of an electrical angle of 30 degrees in FIG. 7. In FIG. 7, in the case where the grooves 24a and 24b are not provided, the position of the electrical angle of 30 degrees is a stability point as described in the first embodiment. However, in the case where the grooves 24a and 24b are provided, the position of the electrical angle of 30 degrees is changed into an instability point. A factor of this effect will be described with reference to FIGS. 8 and 9.

FIG. 8 illustrates magnetic flux distribution in the vicinity of an air gap at a position of the rotor of the electrical angle of 30 degrees in the case where the grooves 24a and 24b are provided, and FIG. 9 illustrates magnetic flux distribution in the case where the grooves 24a and 24b are not provided. In FIG. 9, the magnetic flux having passed through the permanent magnet 22 passes through a route of the rotor core 21a→the air gap→the stator tooth 12→the air gap→the rotor core 21a. Accordingly, the rotor core 21a and the stator tooth 12 strongly attract each other, and this becomes a factor of forming a stability point. Meanwhile, in FIG. 8, since the grooves 24a and 24b are provided on the route, the air gap is enlarged, and force between the rotor core 21a and the stator tooth 12 attracting each other is weakened, and the stability point is turned into an instability point.

As described above, the grooves 24a and 24b are provided in the surfaces of the rotor cores in a manner symmetric about the center line of the permanent magnet in the circumferential direction and in the vicinities of the permanent magnet, whereby the cogging torque has an increase in order and has a higher frequency, so that an effect of more easy reduction of vibration/noise can be obtained.

### Third Embodiment

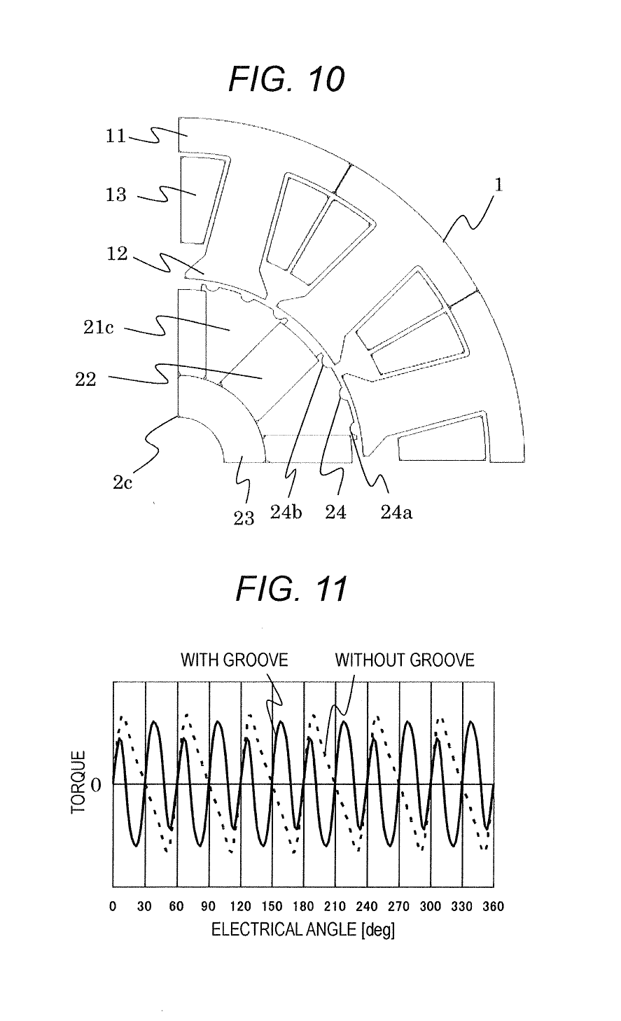

Hereinafter, a third embodiment of the present invention will be described with reference to FIGS. 10 and 11. In the embodiment, as an example of a combination of two poles of a rotor magnetic pole with respect to three stator teeth, a case of twelve stator teeth and eight poles of the rotor magnetic pole will be described.

FIG. 10 illustrates an ¼ cross sectional view of a permanent magnet rotating electrical machine of the third embodiment of the present invention. Differences from FIG. 1 are that the rotor core 21 is changed into a rotor core 21c, and grooves 24a and 24b are formed in a surface of the rotor core 21c, the surface facing a stator 1, in a manner symmetric about a center line of a permanent magnet 22 in a circumferential direction and in vicinities of the permanent magnets 22, in addition to a groove 24 formed on a center line of the rotor core 21c in the circumferential direction. Accordingly, the rotor 2 is changed into a rotor 2c. Note that a pitch between two grooves lining across the permanent magnet 22 in the circumferential direction approximately accords with the width of a surface of a stator tooth 12 in the circumferential direction, the surface facing the rotor 2c. Things other than the above are similar to FIG. 1.

FIG. 11 illustrates waves of cogging torque in a case where the grooves 24, 24a, and 24b are provided in the surface of the rotor core and in a case where the grooves are not provided. Here, the case where the grooves are not provided refers to the shape illustrated in FIG. 2. The position of the rotor in FIG. 10 corresponds to the position of an electrical angle of 30 degrees in FIG. 11. In FIG. 11, in the case where the grooves are provided, the position of the electrical angle of 30 degrees is changed from a stability point to an instability point, cogging torque in the vicinity of the electrical angle of 0 degree is reduced. This is a multiple effect of the factors described in the first embodiment and the second embodiment.

As described above, the grooves are provided in the surface of the rotor core in a manner symmetric about the center line of the permanent magnet in the circumferential direction and in the vicinities of the permanent magnets, and on the center line of the rotor core in the circumferential direction, whereby the cogging torque has a decrease in amplitude, has an increase in order, and has a higher frequency, so that an effect of reduction of vibration/noise can be obtained.

### Fourth Embodiment

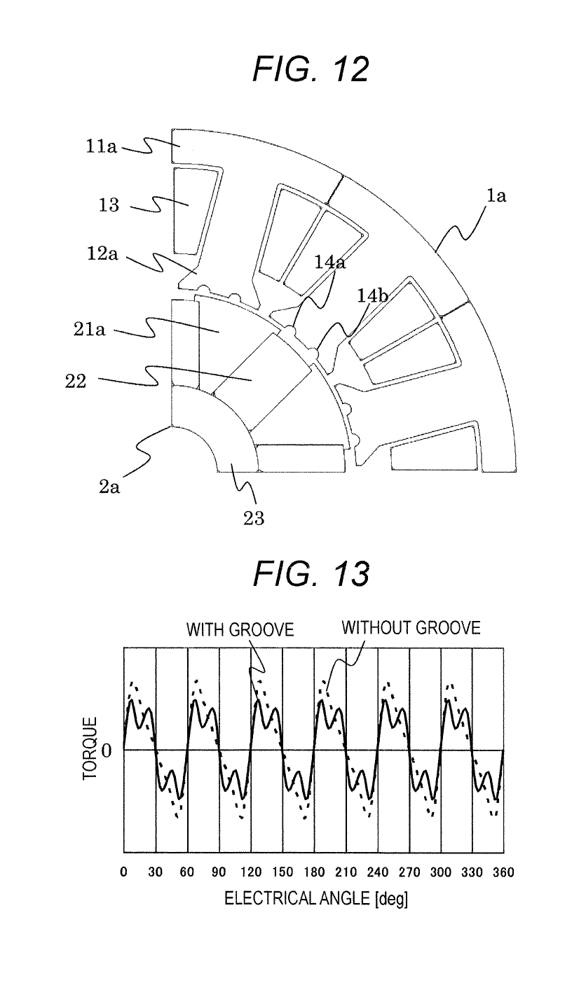

Hereinafter, a fourth embodiment of the present invention will be described with reference to FIGS. 12 and 13. In the embodiment, as an example of a combination of two poles of a rotor magnetic pole with respect to three stator teeth, a case of twelve stator teeth and eight poles of the rotor magnetic pole will be described.

FIG. 12 illustrates an ¼ cross sectional view of a permanent magnet rotating electrical machine of the fourth embodiment of the present invention. Differences from FIG. 1 are that the rotor core 21 is changed into a rotor core 21a provided with no groove in a surface, the stator core 11 is changed into a stator core 11a, the stator teeth 12 is changed into stator teeth 12a, and grooves 14a and 14b are formed in a surface of the stator tooth 12a, the surface facing a rotor 2a, in a manner symmetric about a center line of the stator tooth 12a in a circumferential direction. Accordingly, the rotor 2 is changed into the rotor 2a, and the stator 1 is changed into a stator 1a. Note that a pitch between the grooves 14a and 14b provided symmetric about the center line of the stator tooth in the circumferential direction is approximately ⅓ of a stator slot pitch. Things other than the above are similar to FIG. 1.

FIG. 13 illustrates waves of cogging torque in a case where the grooves 14a and 14b are provided in the surface of the stator tooth 12a and in a case where the grooves are not provided. Here, the case where the grooves are not provided refers to the shape illustrated in FIG. 2. In the case where the grooves are provided in FIG. 13, higher order components of the cogging torque are increased compared with the case where the grooves are not provided, and peaks thereof are decreased. This is because the number of stator teeth is apparently increased threefold by the two grooves provided in the end of the stator teeth, and an apparent least common multiple of the number of stator teeth and the number of rotor magnetic poles becomes threefold, so that the order of the cogging torque becomes higher.

As described above, the grooves 14a and 14b are provided in the surface of the stator tooth in a manner symmetric about the center line of the stator tooth in the circumferential direction, whereby the amplitude of the cogging torque is decreased and an effect of reduction of vibration/noise can be obtained.

### Fifth Embodiment

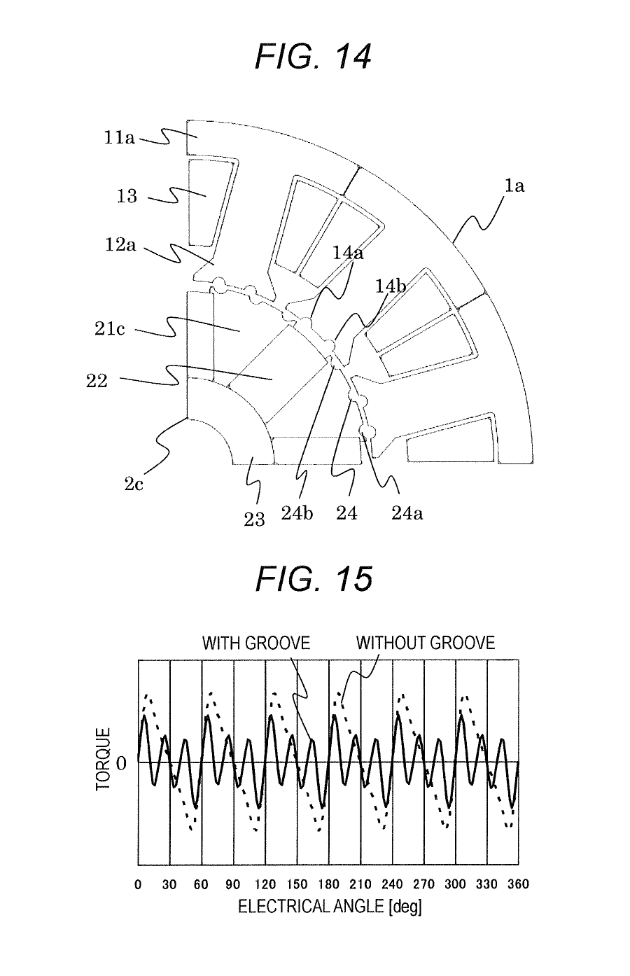

Hereinafter, a fifth embodiment of the present invention will be described with reference to FIGS. 14 and 15. In the embodiment, as an example of a combination of two poles of a rotor magnetic pole with respect to three stator teeth, a case of twelve stator teeth and eight poles of the rotor magnetic pole will be described.

FIG. 14 illustrates an ¼ cross sectional view of a permanent magnet rotating electrical machine of the fifth embodiment of the present invention. The first difference from FIG. 1 is that the stator core 11 is changed into a stator core 11a, the stator teeth 12 is changed into stator teeth 12a, and grooves 14a and 14b are formed in a surface of the stator tooth 12a, the surface facing the rotor, in a manner symmetric about a center line of the stator tooth 12a in the circumferential direction. Accordingly, the stator 1 is changed into a stator 1a. The second difference is that the rotor core 21 is changed into a rotor core 21c, and grooves 24a and 24b are formed in a surface of the rotor core 21c, the surface facing the stator 1a, in a manner symmetric about a center line of a permanent magnet 22 in the circumferential direction and in vicinities of the permanent magnets 22, in addition to a groove 24 formed on a center line of the rotor core 21c in the circumferential direction. Accordingly, the rotor 2 is changed into a rotor 2c. Note that a pitch between the grooves 14a and 14b provided symmetric about the center line of the stator tooth 12a in the circumferential direction is approximately ⅓ of a stator slot pitch, and also a pitch between two grooves lining across the permanent magnet 22 in the circumferential direction approximately accords with the width of a surface of the stator tooth 12a, the surface facing the rotor 2c in the circumferential direction. Things other than the above are similar to FIG. 1.

FIG. 15 illustrates waves of cogging torque in a case where the grooves 14a, 14b, 24, 24a, and 24b are provided and in a case where the grooves are not provided. Here, the case where the grooves are not provided refers to the shape illustrated in FIG. 2. In a case where the grooves are provided in FIG. 15, higher order components of the cogging torque are increased compared with the case where the grooves are not provided, and peaks thereof are decreased. This is a multiple effect of the factors described in the third embodiment and the fourth embodiment.

As described above, the groove 24 is provided in the surface of the rotor core and on the center line of the rotor core in the circumferential direction, the grooves 24a and 24b are provided in the surface of the rotor core in a manner symmetric about the center line of the permanent magnet in the circumferential direction and in the vicinities of the permanent magnet, and the grooves 14a and 14b are provided in the surface of the stator tooth in a manner symmetric about the center line of the stator tooth in the circumferential direction, whereby the togging torque has a decrease in amplitude, and has an increase in order and has a higher frequency, so that an effect of reduction of vibration/noise can be obtained.

### Sixth Embodiment

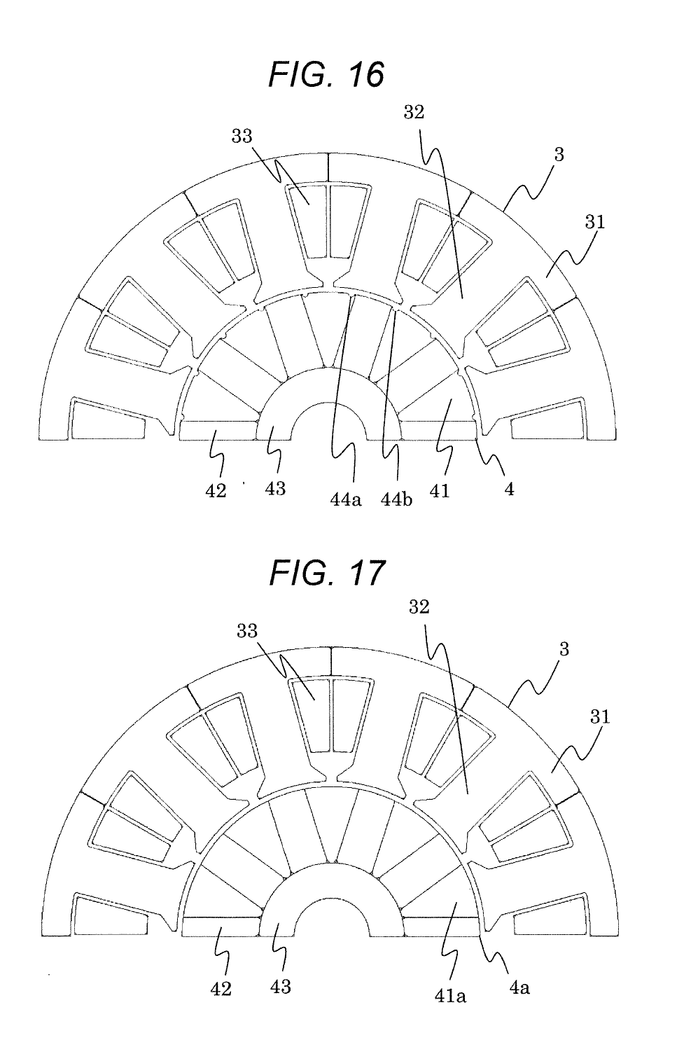

Hereinafter, a sixth embodiment of the present invention will be described with reference to FIGS. 16 to 19. In the embodiment, as an example of a combination of ten poles of the rotor magnetic pole with respect to twelve stator teeth will be described.

FIG. 16 is an ½ cross sectional view of a permanent magnet rotating electrical machine of the sixth embodiment of the present invention. The permanent magnet rotating electrical machine includes a stator 3 and a rotor 4 facing at an inside in a radial direction of the stator 3, and an air gap exists between the stator 3 and the rotor 4. The stator 3 includes a stator core 31 in which a plurality of magnetic steel plates is layered, and the stator core 31 includes a plurality of stator teeth 32, and a stator winding 33 is wound around each tooth in a concentrated winding manner. The rotor 4 has a rotor core 41 in which a plurality of magnetic steel plates is layered and a permanent magnet 42 having a cross section longer in a radial direction than in a circumferential direction alternately arranged in the circumferential direction. The permanent magnet 42 is magnetized in the circumferential direction, and adjacent magnets are alternately magnetized such that magnetization directions of the adjacent magnets face each other. A member in contact with the rotor core 41 and the permanent magnet 42 at an inside in a radial direction thereof is configured of a nonmagnetic material 43, and a shaft (not illustrated) is arranged in a further inside in the radial direction.

In a position of the rotor, which serves as an instability point in a case where the rotor 4 is not provided with grooves, grooves 44a and 44b are formed in positions that approximately accord with positions of slot opening portions of the stator teeth 32 in the circumferential direction, for example, in positions symmetric about a center line of the permanent magnet 42 in the circumferential direction and in vicinities of the permanent magnet 42, from among the surface of the rotor core 41, the surface facing the stator 3.

FIG. 17 is an ½ cross sectional view of a permanent magnet rotating electrical machine provided with no groove in a surface of a rotor core. Differences from FIG. 16 are that the rotor core 41 is changed into a rotor core 41a, and no groove is provided in a surface. Accordingly, the rotor 4 is changed into a rotor 4a. Things other than the above are similar to FIG. 16.

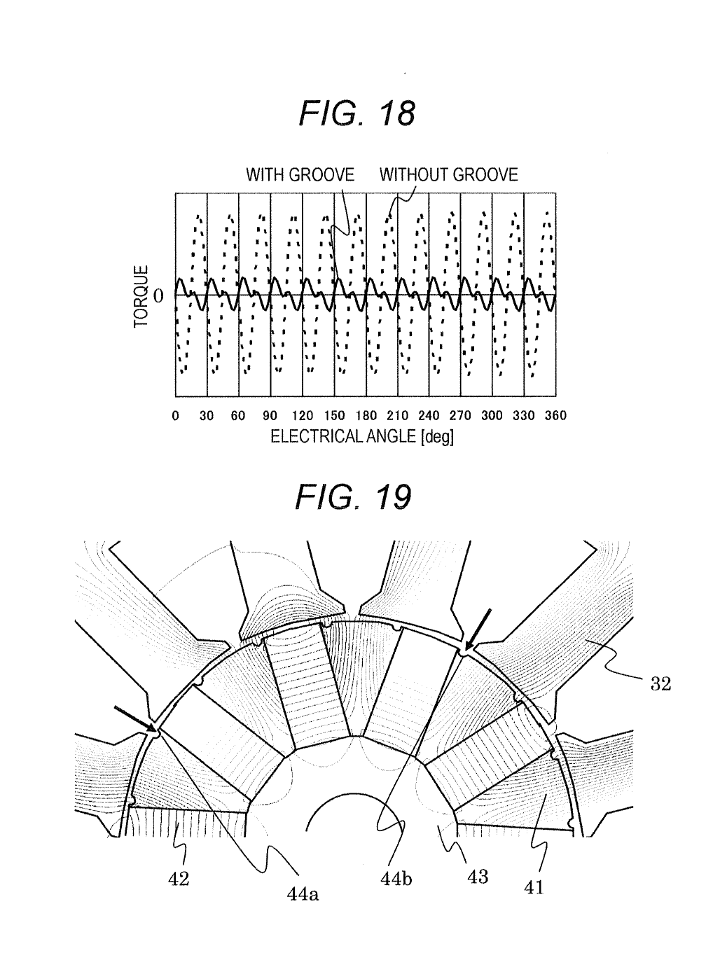

FIG. 18 illustrates waves of cogging torque in a case where the grooves 44a and 44b are provided in the surfaces of the rotor cores and in a case where the grooves are not provided. Here, the case where the grooves 44a and 44b are not provided refers to the shape illustrated in FIG. 17. The positions of the rotors in FIGS. 16 and 17 correspond to the position of an electrical angle of 30 degrees in FIG. 18. In FIG. 18, in the case where the grooves 44a and 44b are not provided, negative torque acts when the electrical angle proceeds in the forward direction from 30 degrees, and positive torque acts when the electrical angle proceeds in the backward direction. Therefore, even the electrical angle proceeds in either direction, the torque acts in a direction of an original position to which the rotor is returned. That is, the position of the electrical angle of 30 degrees is a stability point. Due to symmetry of the shapes of the stator and the rotor, the stability points appear by every electrical angle of 30 degrees such as the electrical angles of 60 degrees and 90 degrees. Meanwhile, the electrical angles of 15 degrees, 45 degrees, and the like are instability points, which appear by every electrical angle of 30 degrees.

In the case where the grooves 44a and 44b are provided in FIG. 18, the instability point in the vicinity of the electrical angle of 15 degrees is turned into a stability point. A factor of this effect will be described with reference to FIG. 19.

FIG. 19 illustrates magnetic flux distribution in the vicinity of an air gap at a position of the rotor of the electrical angle of 15 degrees in the case where the grooves 44a and 44b are provided. As indicated by arrows in FIG. 19, parts of the grooves 44a and 44b provided in the surfaces of the rotor cores accord with the slot opening portions of the stator teeth. When the rotor moves in the forward direction or in the backward direction from the position in FIG. 19, the grooves indicated by the arrows face the stator teeth, and the air gap between the rotor and the stator is enlarged, and the facing area of the rotor and the stator teeth becomes smaller. Therefore, torque returning to the position of FIG. 19 acts, and the instability point in FIG. 18 is turned into a stability point.

As described above, in a position of the rotor, which serves as an instability point in a case where the rotor is not provided with grooves, the grooves are provided in the positions that approximately accord with the slot opening portions of the stator teeth in the circumferential direction, for example, in the positions symmetric about the center line of the permanent magnet in the circumferential direction and in the vicinities of the permanent magnets, from among the surface of the rotor core, whereby the amplitude of the cogging torque is decreased and an effect of reduction of vibration/noise can be obtained.

### Seventh Embodiment

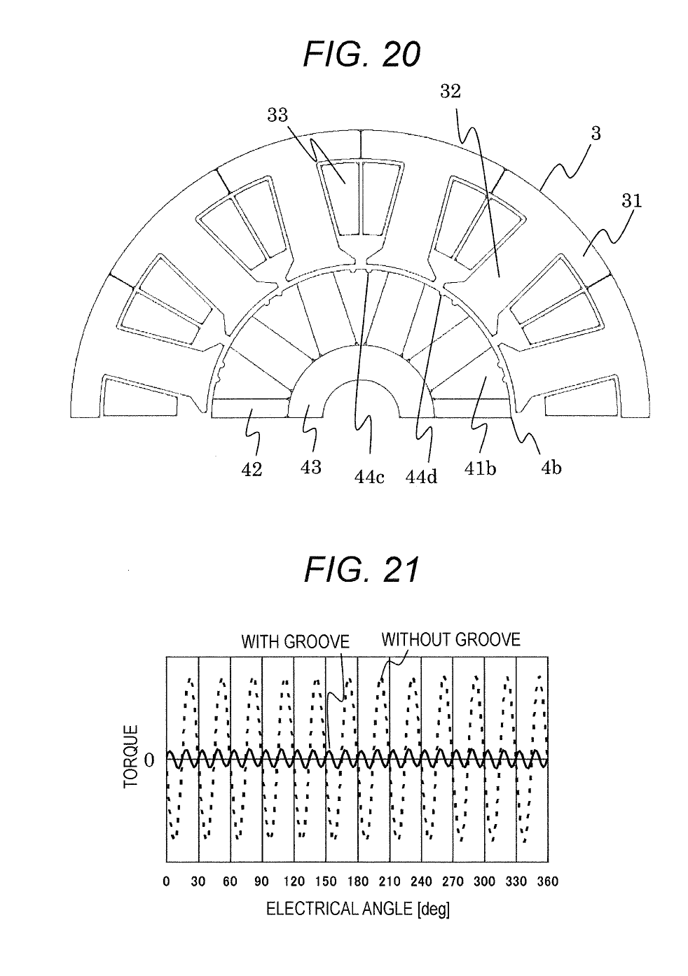

Hereinafter, a seventh embodiment of the present invention will be described with reference to FIGS. 20 to 22. In the embodiment, as an example of a combination of ten poles of the rotor magnetic pole with respect to twelve stator teeth will be described.

FIG. 20 is an ½ cross sectional view of a permanent magnet rotating electrical machine of the seventh embodiment of the present invention. Differences from FIG. 16 are that the rotor core 41 is changed into a rotor core 41b, and grooves 44c and 44d are formed in a surface of the rotor core 41b, the surface facing a stator 3, in a manner symmetric about a center line of a permanent magnet 42 in the circumferential direction and in vicinities of the center of the rotor core 41b in the circumferential direction. Accordingly, the rotor 4 is changed into a rotor 4b. Things other than the above are similar to FIG. 16.

FIG. 21 illustrates waves of cogging torque in a case where the grooves 44c and 44d are provided in the surface of the rotor core and in a case where the grooves are not provided. Here, the case where the grooves 44c and 44d are not provided refers to the shape illustrated in FIG. 17. The positions of the rotors in FIGS. 17 and 20 correspond to the position of an electrical angle of 30 degrees in FIG. 21. In FIG. 21, in the case where the grooves 44c and 44d are not provided, the position of the electrical angle of 30 degrees is a stability point as described in the sixth embodiment. Due to symmetry of the shapes of the stator and the rotor, the stability points appear by every electrical angle of 30 degrees such as the electrical angles of 60 degrees and 90 degrees. Meanwhile, the electrical angles of 15 degrees, 45 degrees, and the like are instability points, which appear by every electrical angle of 30 degrees.

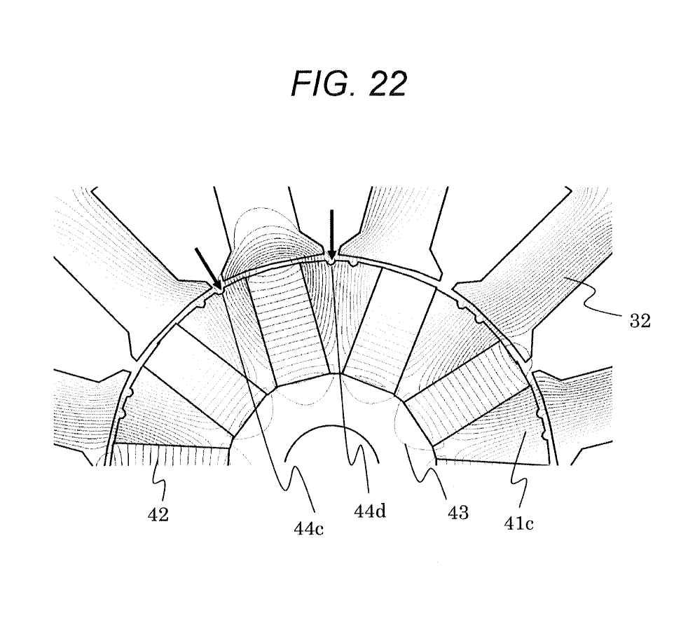

In the case where the grooves 44c and 44d are provided in FIG. 21, the instability point in the vicinity of the electrical angle of 15 degrees is considerably eased. A factor of this effect will be described with reference to FIG. 22.

FIG. 22 illustrates magnetic flux distribution in the vicinity of an air gap at a position of the rotor of the electrical angle of 15 degrees in the case where the grooves 44c and 44d are provided. As indicated by arrows in FIG. 22, parts of the grooves 44c and 44d provided in the surfaces of the rotor cores accord with the slot opening portions of the stator teeth. When the rotor moves in the forward direction or in the backward direction from the position in FIG. 22, the grooves indicated by the arrows face the stator teeth, the air gap between the rotor and the stator is enlarged, and the facing area of the rotor and the stator teeth becomes smaller. Therefore, torque returning to the position of FIG. 22 acts, and the instability point in FIG. 21 is considerably eased.

As described above, in a position of the rotor core, which serves as an instability point in a case where the rotor is not provided with grooves, grooves are provided in positions that approximately accord with the slot opening portions of the stator teeth in the circumferential direction, for example, in the positions symmetric about the center line of the permanent magnet in the circumferential direction and in the vicinities of the center of the rotor core in the circumferential direction, whereby the amplitude of the cogging torque is decreased and an effect of reduction of vibration/noise can be obtained.

### Other Embodiments

Note that the description has been given using the examples of eight poles of the rotor magnetic pole with respect to twelve stator teeth and the examples of ten poles of the rotor magnetic pole with respect to twelve stator teeth. As for the former case, a combination of six poles of the rotor magnetic pole with respect to nine stator teeth, a combination of four poles of the rotor magnetic pole with respect to six stator teeth, and the like can be similarly realized as long as it is a combination of two poles of the rotor magnetic pole with respect to three stator teeth. As for the latter case, other combinations such as a combination of fourteen poles of the rotor magnetic pole with respect to twelve rotor teeth, and a combination of eight poles of the rotor magnetic pole with respect to nine rotator teeth can be similarly realized.

Further, although a case has been described in which a stator is arranged outside and the rotor is arranged inside, a case can also be similarly realized where the stator is arranged inside and the rotor is arranged outside.

Further, although a case has been described in which the permanent magnet has the cross section longer in the radial direction than in the circumferential direction and the permanent magnet is magnetized in the circumferential direction, a case can be similarly realized where the permanent magnet has the cross section longer in the circumferential direction than in the radial direction and the permanent magnet is magnetized in the radial direction.

Further, although a case has been described in which the rotor core and the permanent magnet are alternately arranged in the circumferential direction, a case can be similarly realized where the rotor core continues in the circumferential direction or a permanent magnet is embedded in an integrated rotor cores.

Further, although an example of a radial gap type having an air gap in an outer circumferential direction of a rotation axis has been described, an axial-gap type having an air gap in an axial direction of the rotation axis or a linear type that drives linearly can be similarly realized.

What is claimed is:

1. A permanent magnet rotating electrical machine comprising:
a stator including a stator core and a winding wound around a teeth portion of the stator core;
a rotor rotatably arranged with respect to the stator with a gap, and in which a rotor core and a plurality of permanent magnets having different poles are alternately arranged in a circumferential direction; and
a groove provided in a surface of the rotor core, the surface facing the stator, in a manner approximately symmetric about a center line of the permanent magnet in the circumferential direction.

2. The permanent magnet rotating electrical machine according to claim 1, wherein the groove is provided on an approximate center line of the rotor core in the circumferential direction.

3. The permanent magnet rotating electrical machine according to claim 1, wherein the groove is provided in a vicinity of the permanent magnet.

4. The permanent magnet rotating electrical machine according to claim 1, wherein a pitch of the grooves in the circumferential direction approximately accords with a width of a surface of the stator tooth, the surface facing the rotor, in the circumferential direction.

5. The permanent magnet rotating electrical machine according to claim 1, wherein the grooves are provided on an approximate center line of the rotor core in the circumferential direction and in a vicinity of the permanent magnet.

6. The permanent magnet rotating electrical machine according to claim 1, wherein a position of the groove in the circumferential direction is provided between adjacent stator teeth at a position of the rotor, which serves as an instability point in a case where there is no groove.

7. A permanent magnet rotating electrical machine comprising:
a stator including a stator core and a winding wound around a teeth portion of the stator core;
a rotor rotatably arranged with respect to the stator with a gap, and in which a rotor core and a plurality of permanent magnets having different poles are alternately arranged in a circumferential direction; and
a groove provided in a surface of the stator tooth, the surface facing the rotor, in a manner approximately symmetric about a center line of the stator tooth in the circumferential direction.

8. The permanent magnet rotating electrical machine according to claim 7, wherein a pitch of the grooves in the circumferential direction is approximately ⅓ of a pitch of the stator teeth.

9. The permanent magnet rotating electrical machine according to claim 1, wherein a groove is provided in a surface of the stator tooth, the surface facing the rotor, in a manner symmetric about a center line of the stator tooth in the circumferential direction.

10. A permanent magnet rotating electrical machine comprising:
a stator including a stator core and a winding wound around a teeth portion of the stator core;
a rotor rotatably arranged with respect to the stator with a gap, and in which a rotor core and a plurality of permanent magnets having different poles are alternately arranged in a circumferential direction; and
a groove provided in at least one of a surface of the rotor core, the surface facing the stator, and a surface of the stator teeth portion, the surface facing the rotor, at a position easing instability in a position of the rotor, which serves as an instability point.

11. A permanent magnet rotating electrical machine comprising:
a stator including a stator core and a winding wound around a teeth portion of the stator core;
a rotor rotatably arranged with respect to the stator with a gap, and in which a rotor core and a plurality of permanent magnets having different poles are alternately arranged in a circumferential direction; and
a groove provided in at least one of a surface of the rotor core, the surface facing the stator, and a surface of the stator teeth portion, the surface facing the rotor, at a position inhibiting stability in a position of the rotor, which serves as a stability point.
